(19) United States
(12) Patent Application Publication
(10) Pub. No.: US 2023/0342314 A1
(43) Pub. Date: Oct. 26, 2023

(54) Memory Request Timeouts Using a Common Counter

(71) Applicant: Google LLC, Mountain View, CA (US)

(72) Inventors: Nagaraj Ashok Putti, Bangalore (IN); Vyagrheswarudu Durga Nainala, Bangalore (IN); Gopi Neela, Bangaluru (IN); Abhra Bagchi, Bangalore (IN)

(73) Assignee: Google LLC, Mountain View, CA (US)

(21) Appl. No.: 18/044,353

(22) PCT Filed: Sep. 14, 2020
(86) PCT No.: PCT/US2020/050744

§ 371 Date: Mar. 7, 2023

(51) Int. Cl. G06F 13/16

(52) U.S. Cl. CPC G06F 13/1689; G06F 13/1673

(57) ABSTRACT

Techniques and apparatuses are described that enable memory request timeouts using a common counter. A memory request is received, and a common count timeout is generated for the memory request based on a common count at a time of receipt and a latency requirement of the memory request. Common count timeouts of one or more related memory requests within a memory request buffer (if they exist) are adjusted as needed, and the memory request is placed in the memory request buffer. The common count is incremented, and the memory request is indicated as timed out in response to an incrementation of the common count matching the common count timeout for the memory request.

### BACKGROUND

Modern computing devices process large numbers of read and write memory requests from requesting clients (e.g., operating systems, applications, or components). Because the memory requests cannot all be served on the next cycle, the memory requests are often placed in a memory request buffer, and an arbiter grants (or declines) the memory requests based on an arbitration scheme.

One aspect that is often used for memory request arbitration are timeouts, which affect quality of service for requesting clients. Memory requests generally have associated latency requirements (e.g., how long they can wait in the memory request buffer before being granted). When a request has been waiting in the memory request buffer for longer than its latency requirement, it is flagged as being timed out, such that the arbiter can then prioritize the timed-out memory requests for grant.

Traditionally, dedicated counters are used for each memory request in the memory request buffer. While this approach can effectively indicate that memory requests have timed-out, it requires a large amount of memory dedicated to the counters and consumes large amounts of power. Furthermore, such techniques fail to account for memory request dependencies (e.g., memory requests that need to be granted prior to other memory requests), which can lead to memory requests not meeting their latency requirements.

### SUMMARY

Techniques and apparatuses are described that enable memory request timeouts using a common counter. These techniques and apparatuses enable a common counter to be used to track and indicate timeouts of a plurality of memory requests. Each of the memory requests has an associated common count timeout (e.g., when the respective memory request will time out based on a count of the common counter) that is based on a latency requirement of the memory request and the common count at a time the memory request is received. The count of the common counter (hereinafter referred to as a “common count”) is incremented, and the memory requests are indicated as timed out when the common count matches their respective common count timeouts.

Aspects described below include a memory controller comprising a processor and a computer-readable storage media device comprising instructions that, when executed by the processor, cause the processor to receive a memory request and determine, based on the memory request, a latency requirement of the memory request. The instructions then cause the processor to calculate a common count timeout for the memory request based on a common count at a time the memory request is received and the latency requirement of the memory request. The instructions further cause the processor to add the memory request along with the calculated common count timeout to a memory request buffer, increment the common count, and compare each incrementation of the common count to the common count timeout for the memory request. The instructions then cause the processor to, responsive to an incrementation of the common count matching the common count timeout for the memory request, provide an indication that the memory request has timed out.

Aspects described below also include a method performed by a memory controller. The method comprises receiving a memory request and determining, based on the memory request, a latency requirement of the memory request. The method further comprises calculating a common count timeout for the memory request based on a common count at a time the memory request is received and the latency requirement of the memory request. The method comprises then adding the memory request along with the calculated common count timeout to a memory request buffer, incrementing the common count, and comparing each incrementation of the common count to the common count timeout for the memory request. The method further comprises responsive to an incrementation of the common count matching the common count timeout for the memory request, providing an indication that the memory request has timed out.

### BRIEF DESCRIPTION OF THE DRAWINGS

Apparatuses of and techniques enabling memory request timeout using a common counter are described with reference to the following drawings. The same numbers are used throughout the drawings to reference like features and components:

FIG. 1 illustrates an example process flow for memory request timeouts using a common counter;

FIG. 2 illustrates an example electronic device in which memory request timeouts using a common counter can be implemented;

FIG. 3 is an example illustration of a common counter;

FIG. 4 is an example illustration of memory request timeouts using a common counter and a memory request dependency; and

FIG. 5 illustrates an example method for memory request timeouts using a common counter and an optional memory request dependency.

### DETAILED DESCRIPTION

### Overview

Memory requests have associated latency requirements, which, if not met, may degrade quality of service for requesting clients. Once a memory request has been in a memory request buffer for a certain amount of time (e.g., based on its latency requirement), it is considered to have “timed out.” Timeouts are an important aspect of memory request arbitration and ensure that memory requests are served in a timely manner while also ensuring that memory bandwidth is fully utilized. Traditional techniques of handling timeouts, however, utilize a dedicated counter/timer for each memory request in a memory request buffer. This may lead to poor memory-utilization and high memory power-consumption. Furthermore, traditional timeout techniques may fail to account for related memory requests within the memory request buffer (e.g., memory request dependency), which may lead to memory requests not meeting their latency requirements.

This document describes techniques and apparatuses that enable a common counter to be used for a plurality of memory requests in a memory request buffer. Each of the memory requests has an associated common count timeout (e.g., when the respective memory request will time out based on a common count of the common counter) that is based on a latency requirement of the memory request and the common count when the request is received. Furthermore, a memory request dependency may be taken into account by looking for related memory requests within the memory request buffer and adjusting common count timeouts for the related memory requests, if necessary. The common count is then incremented, and the memory requests are indicated as having timed out when an incrementation of the common count matches the common count timeout for the memory request.

### Example Process Flow

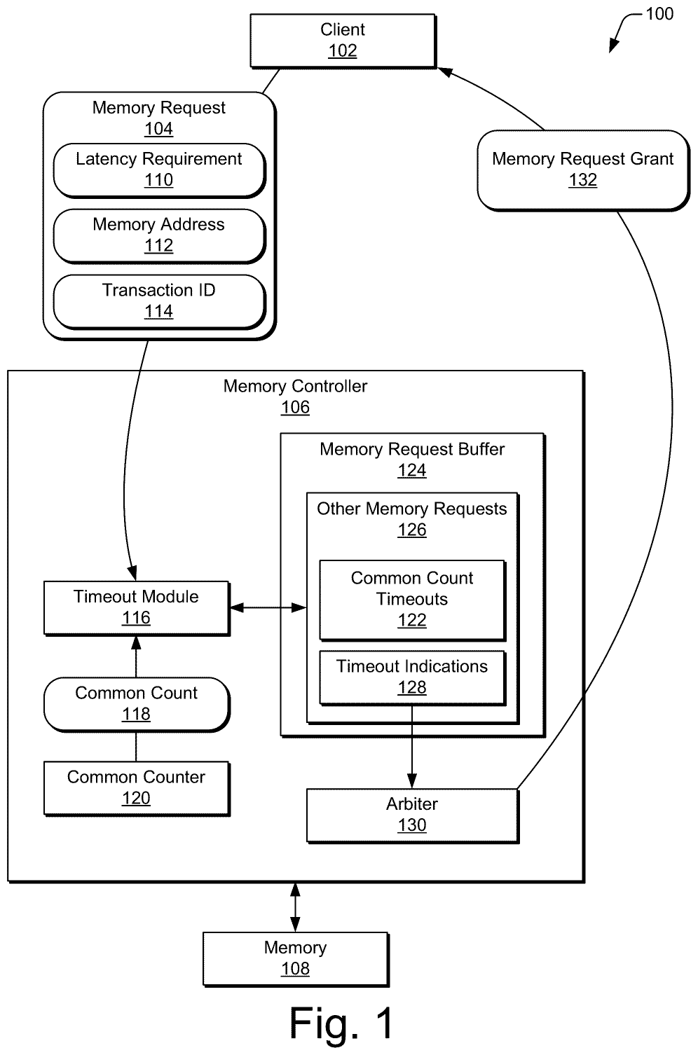

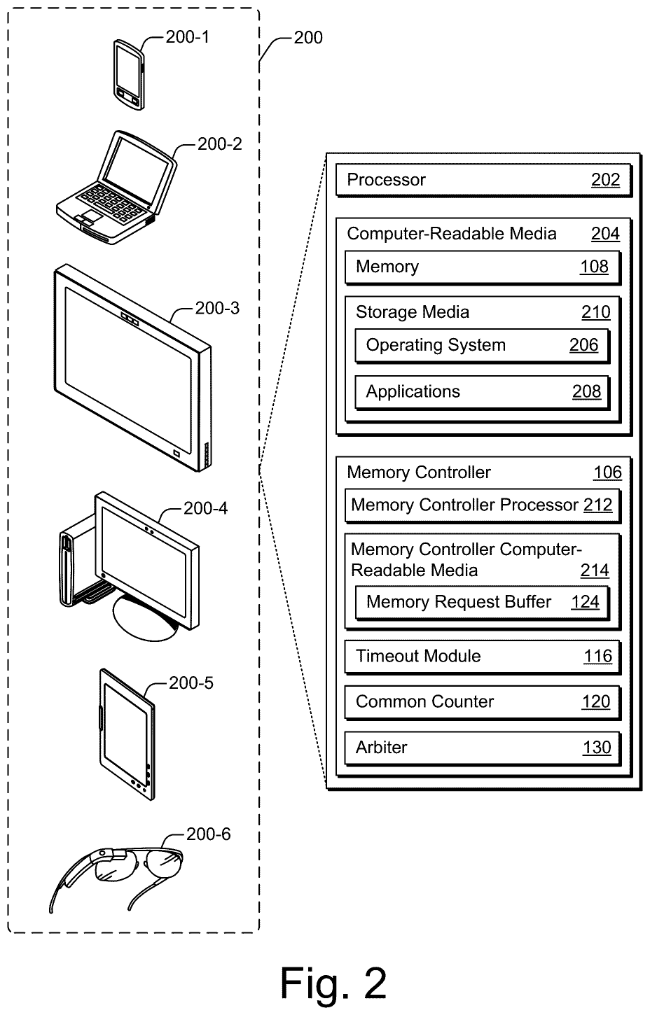

FIG. 1 illustrates an example process flow 100 for memory request timeout using a common counter. The process flow 100 is generally implemented in an electronic device (not shown) that is discussed below in regard to FIG. 2. As shown, the process flow 100 includes a client 102 that generates a memory request 104 for receipt by a memory controller 106. The client 102 may be a component or aspect of an application, operating system, processor, core of a processor, piece of hardware, or any other entity that can generate memory requests requesting to read from or write to a memory 108.

The memory request 104 has a latency requirement 110, memory address 112, and an optional transaction identification (ID) 114. The memory address 112 indicates a physical or virtual memory address associated with the memory request 104. Although discussed in terms of a memory address 112, the memory request 104 may include a request for a plurality of memory addresses. The transaction ID 114 may be included in the memory request 104 and may be used for memory request dependency, as discussed below.

The latency requirement 110 is indicative of when the memory request 104 will time out (e.g., a number of cycles before timeout). Some clients, such as a display or camera, may have strict or short latency requirements compared to other clients, such as a graphical processing unit (GPU). The latency requirement 110 may be determined by the memory controller 106 based on the client 102, a type of the client 102, a type of the request, a virtual channel identification (VCID) associated with the client 102, and/or other information associated with the memory request 104. For example, a timeout module 116 of the memory controller 106 that receives the memory request 104 may use a lookup table or one or more register entries (e.g., a configuration and status register (CSR)) to determine the latency requirement 110 for the memory request 104 based on one or more of the client 102, the type of the client 102, the type of the request, the virtual channel identification (VCID) associated with the client 102, or the other information associated with the memory request 104.

The latency requirement 110 may additionally or alternatively be explicit in the memory request 104 (e.g., grant is requested to occur within a certain number of cycles or time). Furthermore, the client 102 may request a modified latency requirement 110 for the memory request 104 (e.g., the request 104 requests a shortened default latency requirement 110 for the memory request 104 by x number of counts). For example, the client 102 may request to override the latency requirement 110 that would be determined by the memory controller 106 (e.g., in one of the ways described above). The client 102 may also request to amend the latency requirement 110 after it is assigned to the memory request 104. If the client requests to amend the latency requirement 110, the below actions are repeated when the latency requirement 110 is amended.

The timeout module 116 uses the latency requirement 110 and a common count 118 from a common counter 120 at a time the memory request 104 is received to determine a common count timeout 122 for the memory request 104. The common count timeout 122 is indicative of the common count 118 when the memory request 104 will time out. The common counter 120 may include a counter shared by memory requests. Further, the common counter 120 increments the common count 118 and rolls over once a maximum common count is met.

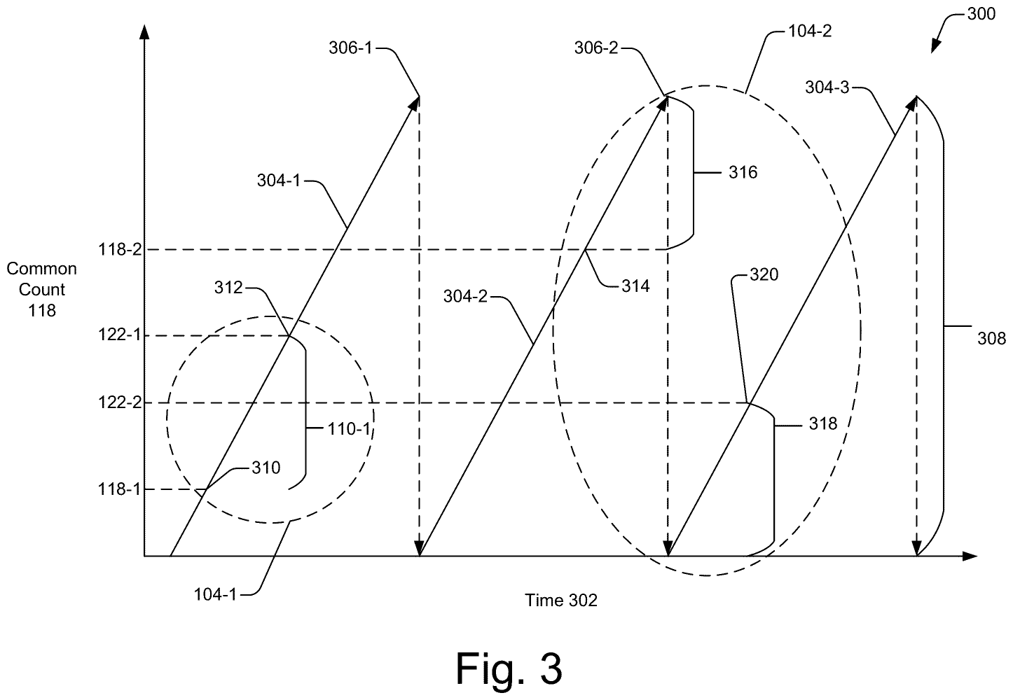

In order to calculate the common count timeout 122 for the memory request 104, the timeout module 116 may add the latency requirement 110 for the memory request 104 to the common count 118 at the time of receipt. The timeout module 116 may calculate the common count timeout 122 in other ways, however. Because the common count 118 rolls over, in some cases, the common count timeout 122 accounts for the rollover. Details of the rollover are discussed below in regard to FIG. 3. Once the common count timeout 122 for the memory request 104 has been established, the timeout module 116 adds the memory request 104, including its common count timeout 122, to a memory request buffer 124. The memory request buffer 124 may comprise both read and write memory requests, or the memory request buffer 124 may be split into a read buffer and a write buffer.

When adding the memory request 104 to the memory request buffer 124 (or in some implementations prior to adding the memory request 104), the timeout module 116 may analyze other memory requests 126 within the memory request buffer 124 and determines if any related memory requests exist in the memory request buffer 124. In order to do so, the timeout module 116 may look for the memory address 112 or the transaction IDs 114 of the other memory requests 126 that match those of the memory request 104.

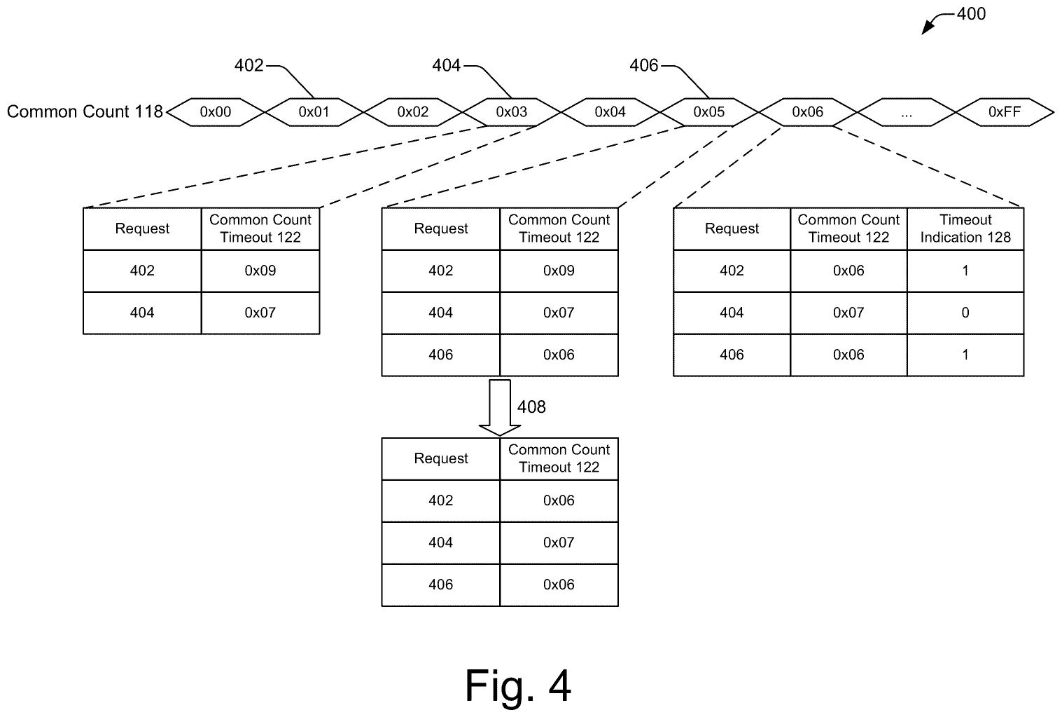

If a related memory request exists, the timeout module 116 then determines if a common count timeout 122 for the related memory request is later than that of the memory request 104. If the common count timeout 122 of the related memory request is later than that of the memory request 104, the timeout module 116 adjusts the common count timeout 122 of the related memory request. The common count timeout 122 of the related memory request is adjusted such that the common count timeout 122 for the memory request 104 is not missed. For example, the memory request 104 may miss its latency requirement if the related memory request, which must be granted first, does not have its common count timeout adjusted. In this way, memory request dependency of related memory requests can be preserved while honoring latency requirements for both memory requests. Adjusting common count timeouts 122 is discussed below in regard to FIG. 4.

Once common count timeouts 122 for related memory requests are adjusted (if needed) and the memory request 104 is added to the memory request buffer 124, the common count 118 is incremented by the common counter 120.

The client 102 may request to modify the latency requirement 110 for the memory request 104 by sending a message for receipt by the timeout module 116 to cut or extend the latency requirement 110 of the memory request 104. The timeout module 116 can then change the latency requirement 110 of the memory request 104 along with respective common count timeouts 122 of related memory requests.

When the common counter 120 has incremented the common count 118 such that matches the common count timeout 122 for the memory request, the timeout module 116 causes the memory request 104 to be indicated as having timed out (e.g., with a timeout indication 128). The timeout indication 128 may be a single bit setting. Similarly, any of the other memory requests 126 with a same common count timeout 122 as the memory request 104 (including any existing related memory requests) may also have timeout indications 128.

The timeout indications 128 are sent to/viewed by an arbiter 130 that grants the memory request 104 based on the timeout indications 128 (or, since timeout is only one factor for use in memory-request arbitration, the arbiter 130 may decline or defer the memory request). In doing so, the arbiter sends a memory grant 132 that corresponds to the memory request 104 to the client 102. If any of the other memory requests 126 (including the related memory requests) have timeout indications 128, they may also have associated memory grants 132 sent to their respective clients 102.

### Example Device

FIG. 2 illustrates an example electronic device 200 in which memory request timeouts using a common counter can be implemented. The electronic device 200 is illustrated with various non-limiting examples of the electronic device 200: a smartphone 200-1, a laptop 200-2, a television 200-3, a desktop 200-4, a tablet 200-5, and a wearable device 200-6. As shown on the right, the electronic device 200 includes at least one processor 202, computer-readable media 204, and the memory controller 106.

The processor 202 (e.g., an application processor, microprocessor, digital-signal processor (DSP), or controller) executes code stored within the computer-readable media 204 to implement an operating system 206 and optionally one or more applications 208 that are stored within a storage media 210 (e.g., one or more non-transitory storage devices such as a hard drive, SSD, flash memory, read-only memory (ROM), EPROM, or EEPROM) of the computer-readable media 204. Although the operating system 206 or the applications 208 generally act as the client 102, as described below, other components can also generate the memory request 104.

The computer-readable media 204, which may be transitory or non-transitory, also includes the memory 108 (e.g., one or more non-transitory computer-readable storage devices such as a random access memory (RAM, DRAM, or SRAM)) that is requested to be accessed (e.g., read from or written to) by the client 102 through the memory request 104.

The memory controller 106 contains a memory controller processor 212 and a memory controller computer-readable media 214. The memory controller processor 212 (e.g., an application processor, microprocessor, digital-signal processor (DSP), or controller) executes code stored within the memory controller computer-readable media 214 to implement the timeout module 116 that is implemented at least partially in hardware of the memory controller 106. The memory controller computer-readable media 214 (e.g., one or more non-transitory storage devices) also includes the memory request buffer 124. The memory controller 106 also contains the common counter 120 and the arbiter 130.

Although described in terms of a separate processing system (e.g., with a separate processor and separate computer-readable media), aspects of the memory controller 106 may be implemented in conjunction with the processor 202 or by the processor 202. Similarly, the memory controller 106 (or processor 202) may perform functions described herein by executing instructions that are stored within the storage media 210. The memory 108 and aspects of the memory controller 106 may also be combined (e.g., implemented as part of an SoC).

Although the memory controller 106 is described in terms of memory requests to access memory 108, the techniques described herein can easily be applied for memory requests to access storage media 210. For example, the memory controller 106 may be a hard drive controller, SSD controller, or the like. Alternatively, the memory controller 106 may be implemented by the processor 202 to access storage media 210.

The electronic device 200 can include one or more communication systems (not shown) that enable wired and/or wireless communication of device data, such as received data, transmitted data, or other information as described above. Example communication systems include NFC transceivers, WPAN radios compliant with various IEEE 802.15 (Bluetooth™) standards, WLAN radios compliant with any of the various IEEE 802.11 (WiFi™) standards, WWAN (3GPP-compliant) radios for cellular telephony, wireless metropolitan area network (WMAN) radios compliant with various IEEE 802.16 (WiMAX™) standards, infrared (IR) transceivers compliant with an Infrared Data Association (IrDA) protocol, and wired local area network (LAN) Ethernet transceivers. In some cases, aspects of the communication system may act as the client 102 by generating memory requests based on received data or data to be transmitted (e.g., a communication buffer).

The electronic device 200 may also include one or more data input ports (not shown) by which any type of data, media content, and/or other inputs can be received, such as user-selectable inputs, messages, applications, music, television content, recorded video content, and any other type of audio, video, and/or image data received from any content and/or data source. The data input ports may include USB ports, coaxial cable ports, fiber optic ports for optical fiber interconnects or cabling, and other serial or parallel connectors (including internal connectors) for flash memory, DVDs, CDs, and the like. These data input ports may be used to couple the electronic device to components, peripherals, or accessories such as keyboards, microphones, or cameras, and may also act as the client 102 by which the memory request 104 is received (e.g., the memory request is generated by a remote device).

Although not shown, the electronic device 200 can also include a system bus, interconnect, crossbar, or data transfer system that couples the various components within the device. A system bus or interconnect can include any one or combination of different bus structures, such as a memory bus or memory controller, a peripheral bus, a universal serial bus, and/or a processor or local bus that utilizes any of a variety of bus architectures.

In some implementations, the electronic device 200 also includes an audio and/or video-processing system (not shown) that processes audio data and/or passes through the audio and video data to an audio system (not shown) and/or to a display system (not shown) (e.g., a video buffer or a screen of a smart phone or camera). The audio system and/or the display system may include any components that process, display, and/or otherwise render audio, video, display, and/or image data and may act as the client 102. Display data and audio signals can be communicated to an audio component and/or to a display component via an RF (radio frequency) link, S-video link, HDMI (high-definition multimedia interface), composite video link, component video link, DVI (digital video interface), analog audio connection, or another similar communication link, such as the media data port. In some implementations, the audio system and/or the display system are external or separate components of the electronic device 200. Alternatively, the display system can be an integrated component of the example electronic device 200, such as part of an integrated touch interface.

### Example Common Counter

FIG. 3 is an example illustration 300 of the common counter 120. The example illustration 300 shows the common count 118 of the common counter 120, from FIG. 1, as a function of time 302 (e.g., cycles). The example illustration 300 shows three common counter cycles 304-1, 304-2, and 304-3. The common counter cycles 304-1 and 304-2 end with common count rollovers at 306-1 and 306-2, respectively. The common count rollovers 306-1 and 306-2 occur when the common count 118 meets a maximum common count 308.

The common counter 120 is a counter that may be $c log 2(N) bits wide, where N is the maximum common count 308. The width of the counter ($c log 2(N)) can be reduced if granularity of common count timeouts 122 is compromised. In such cases, the common counter 120 runs at a slower frequency than an associated device, thereby lumping memory requests that are received within a granularity period as having a same common count 118 for calculation of common count timeouts 122. Similarly, timeout indications 128 are only updated once during the granularity period. The frequency of the common counter 120 may be set by a register (e.g., a CSR). For example, a granularity of 8 cycles reduces storage and the counter width by 3 bits and lumps all transactions within an 8-cycle period as having the same common count 118 for calculation of the common count timeouts 122. Furthermore, the common counter 120 may run at a frequency to account for Dynamic Voltage and Frequency Scaling (DVFS). However, in order to do so, the common count 118 may run through a clock domain crossing (CDC).

A first example of the memory request 104 (104-1) is shown as being received at 310 corresponding to a common count 118-1. The memory request 104-1 also has a latency requirement 110-1. The common count timeout 122-1 for the memory request 104-1 equals a sum of (i) the common count 118 when the memory request 104-1 arrived (118-1) and (ii) the latency requirement 110-1 for the memory request 104-1 (110-1). Accordingly, the memory request 104-1 times out at 312 when the common count 118 equals the common count timeout 122-1 (which corresponds to the sum of the common count 118-1 and the latency requirement 110-1).

A second example of the memory request 104 (104-2) is shown as being received at 314 corresponding to a common count 118-2. The memory request 104-2 also has a latency requirement 110-2. The common count timeout 122-2 for the memory request 104-2 may typically equal a sum of the common count 118-2 and the latency requirement 110-2; however, in this example, the common count rollover 306-2 must be taken into account. Instead, a first portion of the latency requirement 110-2 (316) is added to the common count 118-2 to meet the maximum common count 308. The remainder of the latency requirement 110-2 (318) is then used as the common count timeout 122-2 for the memory request 104-2. In other words, a sum of the first portion of the latency requirement 110-2 (316) and the remainder of the latency requirement 110-2 (318), shown in FIG. 3, equals the latency requirement 110-2. Accordingly, the memory request 104-2 times out at 320 when the common count 118 equals the common count timeout 122-2.

Similar techniques are used to track timeouts for a plurality of memory requests. By sharing the common counter 120, the system utilizes less memory and uses less power than traditional methods of timeout.

### Example Memory Request Dependency

FIG. 4 is an example illustration 400 of memory request timeout using a common counter and memory request dependency. The common count 118 is shown as a series of incremented counts. In the example illustration 400, hexadecimal notation is used for the common count 118 with the maximum common count 308 shown in FIG. 3 as being 0xFF (corresponding to an 8-bit width and 255 counts). However, the maximum common count 308 may be expanded or contracted based on system requirements, and other bases may be used without departing from the scope of the disclosure. Furthermore, for the sake of simplicity, the illustrated memory requests are within a single common count cycle and do not incorporate common count rollovers. However, the illustrated memory requests may integrate common count rollovers within the respective common count timeouts 122, as discussed in regard to FIG. 3.

The example illustration 400 shows memory requests 402, 404, and 406 that are received at common counts 0x01, 0x03, and 0x05, respectively. Memory request 402 has a latency requirement 110 of eight cycles. Thus, its common count timeout 122 is 0x09. Memory request 404, which is not related to memory request 402, has a latency requirement 110 of four cycles; thus, its common count timeout 122 is 0x07. Memory request 406, which is related to memory request 402 but not to memory request 404, has a latency requirement 110 of one cycle; thus, its common count timeout 122 is 0x06.

In order to meet the latency requirements of both memory requests 402 and 406, the common count timeout 122 for memory request 402 is adjusted (408) to match or precede the common count timeout 122 for the memory request 404. For example, memory request 402 may have its common count timeout 122 adjusted a certain number of cycles before that of the memory request 406, so as to precede the common count timeout 122 for the memory request 404. In this way, a blackout delay (due to servicing the memory request 402) does not affect the memory request 406. Because of the adjustment, at 0x06 memory requests 402 and 406 are indicated as having timed out (via timeout indications 128), whereas without accounting for memory request dependency, memory request 402 would not have timed out until 0x09, resulting in memory request 406 waiting until 0x09 and missing its latency requirement 110.

### Example Method

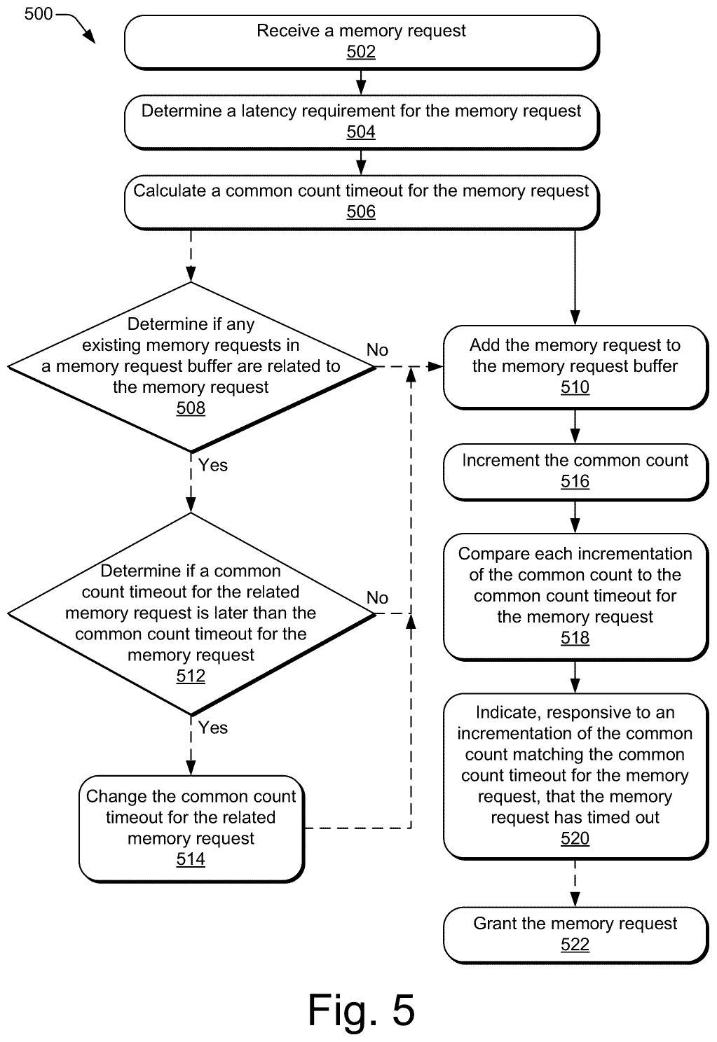

The following discussion describes a method for memory request timeout using a common counter. This method can be implemented utilizing the previously described examples, such as the process flow 100, the electronic device 200, and the illustrations shown in FIGS. 3 and 4. Aspects of this method are illustrated in FIG. 5, which are shown as operations 502 through 522 that are performed by one or more entities (e.g., memory controller 106). The order in which operations of this method are shown and/or described is not intended to be construed as a limitation, and any number or combination of the described method operations can be combined in any order to implement a method or an alternate method.

FIG. 5 illustrates an example method 500 for memory request timeout using a common counter. At 502, a memory request is received. The memory request (e.g., memory request 104) is received from a client and contains a memory address associated with the request and optionally a transaction ID. At 504, a latency requirement for the memory request is determined. The latency requirement (e.g., latency requirement 110) corresponds to a number of cycles before timeout for the request. In some aspects, the latency requirement may be explicit in the request. Alternatively, the latency requirement may be generated based on details of the request (e.g., VCID of the client, type of the client, or from a lookup table).

At 506, a common count timeout for the memory request is calculated. The common count timeout (e.g., common count timeout 122) corresponds to a common count at a time the request is received combined with the latency requirement. In some cases, a rollover of the common count is taken into account by determining an amount of the latency requirement needed to meet a maximum common count, and a remainder of the latency requirement for the request becomes the common count timeout (e.g., as shown in FIG. 3).

At 508, contents of a memory request buffer are analyzed to determine if one or more related memory requests exist. One or more of the other memory requests (e.g., other memory requests 126) may be determined to be related if they share a transaction ID or memory address with the memory request.

If no related memory requests are found, the process adds the memory request to the memory request buffer at 510. The memory request is added to the memory request buffer (e.g., memory request buffer 124), along with its associated common count timeout, memory address, and its transaction ID (if available). If a related memory request is found, the process moves to 512.

At 512, a determination is made as to whether a common count timeout for the related memory request is later than the common count timeout for the memory request. Although later generally refers to a higher common count, if a rollover is associated with either of the requests, the common count timeout of a later transaction may be lower than a common count timeout of a sooner transaction.

If the related memory request does not have a later common count timeout than that of the memory request, the process moves to 510. If the related memory request does have a later common count timeout than the memory request, then the process moves to 514.

At 514, the common count timeout for the related memory request is adjusted to match the common count timeout for the memory request. For example, the common count timeout for the related memory request may be lowered/shortened such that the common count timeout for the memory request is not missed.

Steps 508, 512, and 514 are optional and are related to incorporating transaction dependency into the timeout. Where present, steps 508, 512, and 514 are performed in addition to using a common counter. Regardless of whether common count timeouts for related requests are changed (steps 508, 512, and 514), the process adds the memory request with its associated common count timeout to the memory request buffer at 510.

At 516, the common count is incremented. As discussed in regard to FIG. 3, the common count may roll over in response to reaching a maximum common count.

At 518, each incrementation of the common count is compared to the common count timeout for the memory request.

At 520, the memory request is indicated as having timed out (e.g., via timeout indication 128) responsive to an incrementation of the common count matching the common count timeout for the memory request. If one or more of the other memory requests in the memory request buffer share the same common count timeout as the memory request, they are also indicated as having timed out.

Optionally, at 522, the memory request is granted. As discussed above, timeout is one factor for use in memory-request arbitration; thus, other factors may be utilized for memory grants. Furthermore, the process may send the timeout indication to another entity that grants (or arbitrates on) the request.

The preceding discussion describes a method relating to memory request timeout using a common counter. Aspects of these methods may be implemented in hardware (e.g., fixed logic circuitry), firmware, software, or any combination thereof. These techniques may be realized using one or more of the entities or components shown in FIGS. 1 and 2, which may be further divided, combined, and so on. Thus, these figures illustrate some of the many possible systems or apparatuses capable of employing the described techniques. The entities and components of these figures generally represent software, firmware, hardware, whole devices or networks, or a combination thereof.

### Examples

Example 1: A method performed by a memory controller, the method comprising: receiving a memory request; determining, based on the memory request, a latency requirement for the memory request; calculating a common count timeout for the memory request based on: a common count at a time the memory request is received; and the latency requirement for the memory request; adding the memory request along with the calculated common count timeout to a memory request buffer; incrementing the common count; comparing each incrementation of the common count to the common count timeout for the memory request; and responsive to an incrementation of the common count matching the common count timeout for the memory request, providing an indication that the memory request has timed out.

Example 2: The method of example 1, further comprising storing one or more other memory requests in the memory request buffer, wherein the other memory requests have respective common count timeouts based on the common count.

Example 3: The method of example 2, further comprising determining if any of the other memory requests are related to the memory request.

Example 4: The method of example 3, wherein the determining if any of the other memory requests are related to the memory request comprises comparing a transaction identification for the memory request to respective transaction identifications for the other memory requests.

Example 5: The method of example 3, wherein the determining if any of the other memory requests are related to the memory request comprises comparing a memory address for the memory request to respective memory addresses for the other memory requests.

Example 6: The method of any of examples 3 to 5, further comprising, responsive to determining that one of the other memory requests is a related memory request that is related to the memory request, determining if the common count timeout for the related memory request is later than the common count timeout for the memory request.

Example 7: The method of example 6, further comprising, responsive to determining that the common count timeout for the related memory request is later than the common count timeout for the memory request, changing the common count timeout for the related memory request such that the latency requirement for the memory request and another latency requirement for the related memory request are both met.

Example 8: The method of any preceding example, further comprising incrementing the common count to a maximum common count; and resetting the common count responsive to the maximum common count being met.

Example 9: The method of example 8, wherein the common count timeout for the memory request is further based on the resetting of the common count.

Example 10: The method of any preceding example, wherein the determining the latency requirement comprises determining the latency requirement based on a client from which the memory request is received.

Example 11: The method of example 10, wherein the determining the latency requirement comprises determining the latency requirement based on a lookup table that contains a plurality of clients and latency requirements corresponding to respective clients of the plurality of clients.

Example 12: The method of example 10 or 11, wherein the determining the latency requirement comprises determining the latency requirement further based on a virtual channel identification of the client.

Example 13: The method of any preceding example, further comprising granting (or declining) the memory request subsequent to, or in response to, the indication that the memory request has timed out. Alternatively, the method of any preceding example may further comprise, subsequent to, or in response to, the indication that the memory request has timed out, forwarding the memory request for arbitration by another entity.

Example 14: The method of any preceding example, wherein the common count is indicative of a plurality of cycles of the memory controller.

Example 15: A memory controller comprising: at least one processor; and at least one computer-readable storage media device comprising instructions that, when executed by the at least one processor, cause the processor to perform the method of any preceding example.

Example 16: An apparatus comprising: a processor; a computer-readable storage media; and executable instructions that cause the apparatus or a memory controller of the apparatus to perform the method of any of examples 1-14.

Example 17: A computer-readable storage medium containing instructions that, when executed by one or more processors, cause the one or more processors to perform the method of any of examples 1-14. The computer-readable storage medium of this example may be a transitory or a non-transitory computer-readable storage medium.

Although implementations of memory request timeout using a common counter have been described in language specific to certain features and/or methods, the subject of the appended claims is not necessarily limited to the specific features or methods described. Rather, the specific features and methods are disclosed as example implementations for request timeout using a common counter. Further, although various examples have been described above, with each example having certain features, it should be understood that it is not necessary for a particular feature of one example to be used exclusively with that example. Instead, any of the features described above and/or depicted in the drawings can be combined with any of the examples, in addition to or in substitution for any of the other features of those examples.

1. A method performed by a memory controller, the method comprising:
receiving a memory request;
determining, based on the memory request, a latency parameter for the memory request;
calculating a common count timeout for the memory request based on:
a common count at a time the memory request is received; and
the latency parameter for the memory request;
adding the memory request along with the calculated common count timeout to a memory request buffer;
incrementing the common count;
comparing each incrementation of the common count to the common count timeout for the memory request; and
responsive to an incrementation of the common count matching the common count timeout for the memory request, providing an indication that the memory request has timed out.

2. The method as recited in claim 1, further comprising storing one or more other memory requests in the memory request buffer, wherein the other memory requests have respective common count timeouts based on the common count.

3. The method as recited in claim 2, further comprising determining if each of the other memory requests are related to the memory request.

4. The method as recited in claim 3, wherein the determining if each of the other memory requests are related to the memory request comprises comparing a transaction identification for the memory request to respective transaction identifications for the other memory requests.

5. The method as recited in claim 3, wherein the determining if each of the other memory requests are related to the memory request comprises comparing a memory address for the memory request to respective memory addresses for the other memory requests.

6. The method of as recited in claim 3, further comprising, responsive to determining that one of the other memory requests is a related memory request that is related to the memory request, determining if the common count timeout for the related memory request is later than the common count timeout for the memory request.

7. The method as recited in claim 6, further comprising, responsive to determining that the common count timeout for the related memory request is later than the common count timeout for the memory request, changing the common count timeout for the related memory request such that the latency parameter for the memory request and another latency parameter for the related memory request are both met.

8. The method as recited in claim 1, further comprising:
incrementing the common count to a maximum common count; and
resetting the common count responsive to the maximum common count being met.

9. The method as recited in claim 8, wherein the common count timeout for the memory request is further based on the resetting of the common count.

10. The method as recited in claim 1, wherein the latency parameter is based on a client from which the memory request is received.

11. The method as recited in claim 10, wherein the latency parameter is further based on a lookup table that contains a plurality of clients and latency parameters corresponding to respective clients of the plurality of clients.

12. The method as recited in claim 10, wherein the latency parameter is further based on a virtual channel identification of the client.

13. The method as recited in claim 1, further comprising granting the memory request based on the indication that the memory request has timed out.

14. The method as recited in claim 1, wherein the common count is indicative of a plurality of cycles of the memory controller.

15. (canceled)

16. An apparatus comprising:
a processor;
a memory;
a memory request buffer; and
a memory controller operably coupled to the memory and the memory request buffer, the memory controller configured to:
receive a memory request;
determine, based on the memory request, a latency parameter for the memory request;
calculate a common count timeout for the memory request based on:
a common count at a time the memory request is received; and
the latency parameter for the memory request;
add the memory request along with the calculated common count timeout to the memory request buffer;
increment the common count;
compare each incrementation of the common count to the common count timeout for the memory request; and
responsive to an incrementation of the common count matching the common count timeout for the memory request, provide an indication that the memory request has timed out.

17. The apparatus as recited in claim 16, wherein the memory controller is further configured to:
store one or more other memory requests in the memory request buffer, wherein the other memory requests have respective common count timeouts based on the common count.

18. The apparatus as recited in claim 17, wherein the memory controller is further configured to:
determine if each of the other memory requests are related to the memory request.

19. The apparatus as recited in claim 18, wherein the memory controller is further configured to:
determine if each of the other memory requests are related to the memory request by:
comparing a transaction identification for the memory request to respective transaction identifications for the other memory requests; or
comparing a memory address for the memory request to respective memory addresses for the other memory requests.

20. The apparatus as recited in claim 18, wherein the memory controller is further configured to:
in response to determining that one of the other memory requests is a related memory request that is related to the memory request, determine if the common count timeout for the related memory request is later than the common count timeout for the memory request.

21. The apparatus as recited in claim 16, wherein the memory controller is further configured to:
increment the common count to a maximum common count; and
reset the common count responsive to the maximum common count being met.
